(19) United States
(12) Patent Application Publication
(10) Pub. No.: US 2016/0023306 A1
(43) Pub. Date: Jan. 28, 2016

(54) NOZZLE FOR LASER POWDER BUILD-UP WELDING

(71) Applicant: SIEMENS AKTIENGESELLSCHAFT, München (DE)

(72) Inventors: NIKOLAI ARJAKINE, BERLIN (DE); BERND BURBAUM, FALKENSEE (DE); TORSTEN JOKISCH, NEUENHAGEN BEI BERLIN (DE); EIKE KOHLHOFF, BERLIN (DE); LUKASZ PANEK, BERLIN (DE); SEBASTIAN PIEGERT, LÜBBENAU (DE); CHRISTOPH STARKE, BERLIN (DE)

(21) Appl. No.: 14/781,602

(22) PCT Filed: Mar. 20, 2014
(86) PCT No.: PCT/EP2014/055569

§ 371 Date: Oct. 1, 2015

(30) Foreign Application Priority Data
Apr. 3, 2013 (EP) 13162129.4

(51) Int. Cl. B23K 26/14; B23K 26/144; B23K 26/342

(52) U.S. Cl. CPC B23K 26/1462; B23K 26/342; B23K 26/144; B23K 26/1476

(57) ABSTRACT

A nozzle for laser powder build-up welding, in particular, an annular powder channel for feeding powdery material into a processing region in front of the laser outlet opening, wherein the powder channel is designed in such a way that the angle included between the radially outer wall of the powder channel and the axis of the powder channel is constant or decreases in the direction of the material outlet opening at least in the region extending from the at least one material inlet opening to the material outlet opening is provided.

### CROSS-REFERENCE TO RELATED APPLICATIONS

This application claims priority to PCT Application No. PCT/EP2014/055569, having a filing date of Mar. 20, 2014, based off of European Application No. 13162129.4 having a filing date of Apr. 3, 2015, the entire contents of which are hereby incorporated by reference.

### FIELD OF TECHNOLOGY

The following relates to a nozzle for laser powder build-up welding, comprising a sleeve-shaped nozzle body in which an axial through opening for a processing laser beam, having a laser-entry opening at the rear side thereof and a laser-exit opening at the front side thereof, is configured, wherein the through opening is tapered in particular toward the laser-exit opening and, for the supply of pulverulent material into an operating region ahead of the laser-exit opening, has an annular powder duct which surrounds the through opening across at least part of the axial length thereof and extends coaxially thereto, said operating region having at least one material-entry opening in the radially outer wall thereof and a material-exit opening which is defined by the open front end-side of the powder duct, and tapering toward the front.

### BACKGROUND

The laser powder build-up welding method is generally used for coating workpieces. A laser beam which is directed onto a workpiece to be processed serves here as a heat source in order for pulverulent material to be welded onto the surface of the workpiece. In order for the material to be conveyed into the interaction zone of the laser radiation and the basic material of the workpiece to be processed, coaxial nozzles are generally used.

A coaxial nozzle of this type is known from DE 693 00 757 T2, for example. Said coaxial nozzle comprises a substantially cylindrical nozzle body in which a through opening for the processing laser beam which is to be directed onto the workpiece to be processed is centrally provided, said through opening tapering in a conical manner toward the front side of the nozzle body. The through opening on the rear side defines a laser-entry opening and on the front side a laser-exit opening. On account of the tapering geometry of the through opening, the laser-exit opening has a smaller diameter than the laser-entry opening on the rear side.

In order for pulverulent material to be supplied into a processing region ahead of the laser-exit opening, that is to say into the interaction zone, the nozzle has a powder duct which surrounds the through opening and extends coaxially thereto. Said powder duct tapers from the laser-entry opening toward the laser-exit opening. The powder duct in the rear end region thereof comprises an injection chamber into which the pulverulent material is introduced together with a conveying fluid, in particular an inert gas such as helium or argon. To this end, tangential and radial supply lines which extend from the outside through the nozzle body and open into the injection chamber are provided. The injection chamber at the front is adjoined by a powder-duct portion, the width of which is significantly reduced in relation to the width of the injection chamber. The pulverulent material flows through the injection chamber and the adjoining powder-duct portion of smaller width and exits by way of the material-exit opening which is formed by the front end side of the powder duct, and is configured in an open manner.

On account of the tapering geometry of the powder duct, the pulverulent material is guided in a coaxial manner to the processing laser beam to a point or a region, respectively, below the laser-exit opening. This point or region, respectively, is also referred to as the material focus. The pulverulent material flowing into the material focus in the processing region is welded onto the workpiece by means of the processing laser beam which simultaneously spreads out by way of the through opening and is directed onto the workpiece surface.

Nozzles of this type have been successful in principle in the application of laser powder build-up welding. However, it is considered disadvantageous that the use of said nozzles may lead to malfunctioning on account of blockages of the powder duct by the pulverulent material.

The risk of blockages exists in the case of the known nozzles above all when pulverulent materials having a comparatively small grain fraction in the range of a few up to a few tens of micrometers, in particular 5 to 20 micrometers are employed. Therefore, the pulverulent material in the past were sieved, such that no grain fractions of this magnitude are contained in the material if possible, and the risk of blockages is reduced. Sieving the pulverulent material represents an additional and elaborate operational step.

The disclosed nozzle is not suitable in particular for use in the context of the so-called micro-cladding method, since pulverulent materials having a small grain fraction in the aforementioned range are employed therefor. Since microstructures may also be produced inter alia on curved surfaces by means of the micro-cladding method, there is sizeable interest in providing improved nozzle technology.

### SUMMARY

An aspect as disclosed relates to a nozzle for laser powder build-up welding, which is configured to reduce the risk of blockages.

A further aspect relates to a nozzle of the type mentioned at the outset in that the powder duct is configured in such a manner that the angle enclosed between the radially outer wall of the powder duct and the axis of the powder duct is constant at least in the region which extends from the at least one material-entry opening up to the material-exit opening, or decreases in the direction of the material-exit opening.

It has been demonstrated in fluidic simulations (CFD simulations-computational fluid dynamics) carried out that the configuration of the powder duct according to embodiments of the invention ensures excellent conveyability of the pulverulent material. Conveyability is also very good when using pulverulent materials having a comparatively small grain fraction of a few up to a few tens of micrometers. Therefore, pulverulent materials having such a grain fraction may also be employed. In contrast to the past, elaborate sieving of the pulverulent material to be employed is not required when the nozzle according to embodiments of the invention is used. The nozzle according to embodiments of the invention is furthermore highly suitable for employment in the context of the micro-cladding method. Since materials having a smaller grain fraction may be employed, as with the known nozzles, new processes and applications may moreover be exploited. For example, smaller or larger application rates may be implemented, and the weldability of new alloys for the micro-cladding method may be exploited.

The specific geometry of the powder duct enables particularly trouble-free operation of the nozzle, on account thereof, that inter alia the formation of deposits of pulverulent material in the powder duct is precluded. To this end, the radially outer wall of the powder duct is designed in such a manner that when viewed from the at least one material-entry opening towards the material-exit opening, the angle between the wall and the axis of the powder duct, in relation to a point lying further above, does not increase at any point of the radially outer wall, that is to say that the inclination is not reduced at any point.

In regions in which the inclination is reduced when viewed from the material-entry opening toward the material-exit opening, there are depressions in the outer wall which point toward the outside. It has been demonstrated that in these depressions which represent “regions of eddy water” in the flow profile, pulverant material is deposited. “Powder clusters” may occur. When a “powder cluster” of this type is released from a depression this typically leads to blocking of the powder duct, necessitating an interruption of operation.

In particular in the case in which a nozzle for build-up welding is employed at an attitude, that is to say in a position in which it is tilted in relation to the vertical, the presence of depressions in the radially outer wall facilitates the formation of “powder clusters” and blockages of the powder duct caused thereby. This is to be traced back that under an attitude that region of the outer wall of the powder duct that points to the surface of the workpiece to be processed is tilted in the direction of the horizontal, and that gravity acting on the particles of the pulverulent material facilitates accumulation and deposition in particular in depressions in this region. In the known nozzle, an outwardly directed depression in which deposits of the material arise at an attitude is particularly existent in the region of the injection chamber. Operation of the known nozzle is not possible at an attitude, since material accumulation will arise above all at this point, potentially leading to blocking of the nozzle.

By contrast, the nozzle according to embodiments of the invention has a powder duct having a radially outer wall which is configured so as to be smooth for the case of a constant angle between the outer wall and the axis, and for the case of an increasing angle is configured so as to be curved toward the axis, or has wall transitions which are directed toward the axis for an inwardly discontinuous increase of the angle, respectively. As a consequence, no depressions, corners, or edges in which or on which pulverulent material is deposited are present in the powder duct according to embodiments of the invention.

If the angle between the outer wall and the axis of the powder duct across the region which extends from the material-entry opening, in particular from the edge of the material-entry opening which faces the material-exit opening, up to the material-exit opening is constant, the outer wall in this region has the shape of a truncated-cone jacket. The angle between the outer wall and the axis in this design embodiment corresponds to half the opening angle of the truncated cone. A smoothly configured radially outer wall of the powder duct has proven particularly suitable for preventing deposits of pulverulent material.

If the radially outer wall has curved regions, the angle between the wall and the axis of the powder duct is determined by the angle between the tangent at the respectively curved point and the axis.

In contrast to the known nozzles, the nozzle according to embodiments of the invention for build-up welding may also be operated in a trouble-free manner at an attitude. Since operation is even possible at large attitudes, 3-D structures may be readily generated by way of the nozzle according to embodiments of the invention.

In order for the entire powder duct to be passed through by the pulverulent material, the at least one material-entry opening is preferably provided in the rear end region of the powder duct.

The annular material-exit opening which is defined by the open front end side of the powder duct may in particular include the laser-exit opening of the through opening.

According to one embodiment of the present invention, it is provided that the width of the powder duct at least in the region which extends from the at least one material-entry opening up to the material-exit opening decreases in the direction of the material-exit opening. The value determined by the difference between the radius of the radially outer wall and the radius of the radially inner wall of the powder duct is referred to here as the width of the powder duct. Accordingly, the width decreasing toward the laser-exit opening thus means that the difference of the aforementioned radii decreases. On account of the decrease in the width of the powder duct it is ensured that the velocity of the conveying fluid and of the pulverulent material increases toward the material-exit opening. On account of this acceleration, deposits of material in the powder duct are furthermore avoided.

Alternatively or additionally, the aforementioned object is achieved in that the width of the powder duct in the region which extends from the at least one material-entry opening up to the material-exit opening continuously decreases in the direction of the material-exit opening. The continuous decrease in the width results in continuous acceleration of the conveying fluid and of the pulverulent material mixed therewith, on account of which it is avoided in a particularly reliable manner that material is deposited in the powder duct.

According to one further embodiment, it is provided that the powder duct in the region which extends from the at least one material-entry opening up to the material-exit opening comprises a rear part-portion, in which the width of said powder duct decreases in a more pronounced manner, and a front part-portion, in which the width of said powder duct decreases to a lesser extent.

This design embodiment is particularly advantageous since the powder duct in the region of the material supply, which is performed in that region that faces away from the material-exit opening, may have a comparatively large width which is adapted to the dimensions of the material-entry opening, for example, so as to ensure unobstructed uniform inflow of the pulverulent material. Uniform distribution of the material along the circumferential direction of the powder duct in particular takes place in this part-portion. On account of the comparatively large reduction in the width in this part-portion it is ensured that the width is adjusted over a comparatively short distance from dimensions which are adapted to optimal material supply to dimensions which enable a good material focus, in particular a sufficiently small material focus. That part-portion that adjoins the part-portion of great width reduction is then configured so as to be particularly in the shape of an (annular) gap, the width here decreasing only to a lesser extent toward the material-exit opening. As a result, a particularly good material focus is obtained.

A comparatively small width of the annular material-exit opening, which should be only a few hundred micrometers, for example, is required in particular for the micro-cladding method, so as to obtain a material focus of sufficiently minor diameter which is required for the processing operation. Subdividing the powder duct according to this embodiment enables a sufficiently small focus for the micro-cladding method to be achieved. Moreover, the achieved focus is also particularly homogeneous.

The powder duct preferably has two part-portions. However, it is of course also possible for the powder duct to have further part-portions.

It may furthermore be provided in this embodiment that the radially inner wall of the powder duct in the rear and the front part-portions in each case has the shape of a truncated-cone jacket and for in particular the rear part-portion to have a smaller truncated-cone opening angle than the front part-portion. On account of subdividing the radially inner wall of the powder duct into two truncated-cone-shaped part-portions having different opening angles, a powder duct having one part-portion with a comparatively pronounced reduction in width in the direction of the laser-exit opening and one part-portion with a lesser reduction in width may be obtained in a particularly simple constructive manner. The angular variation in the transition point of the two part-portions here is preferably in the magnitude of a few degrees, in particular in the range of 0.5 to 3°.

Preferably, the front part-portion here may directly adjoin the rear part-portion, and in particular the front and the rear part-portions may in each case extend across approximately half of the region of the powder duct which extends from the at least one material-entry opening up to the material-exit opening, this having been proven to be a particularly suitable division.

As a refinement of embodiments of the invention it is provided that the sleeve-shaped nozzle body has a sleeve-type main element and a sleeve-type insert element which is positioned in the main element, and that the through opening for the processing laser beam is configured in the insert element. The powder duct is then preferably configured between the main element and the insert element. By using a sleeve-type main element and insert element, a nozzle according to embodiments of the invention having a powder duct for the supply of pulverulent material may be obtained in a simple constructive manner. The two sleeve-type components may be readily produced and need only to be placed inside one another in order for a nozzle according to embodiments of the invention having a powder duct to be obtained.

As a refinement of embodiments of the invention it is provided that in the powder duct the transition between the rear end wall and the radially outer wall is configured so as to be rounded. The rounded shape represents an adaptation to the typically circular flow cross section of the pulverulent material which preferably flows into the powder duct through circular or oval material-entry openings, respectively. Should the powder duct have corners or edges in particular in the region of the material supply, the flow profile of the inflowing pulverulent material may be disturbed, and it is prevented that uniform distribution of the material across the circumference of the powder duct is established. The rounded configuration of the powder duct according to this embodiment consequently ensures particularly uniform distribution of the pulverulent material in the circumferential direction of the powder duct. A particularly homogeneous material focus is achieved in this way.

In an advantageous design embodiment of the present invention is may be provided that the at least one material-entry opening is configured in such a manner that pulverulent material can be introduced into the powder duct in the direction of the material-exit opening at an angle in relation to a plane which is perpendicular to the axis of the powder duct. According to this embodiment, the supply direction of the pulvurent material is oriented in such a manner that the material has a velocity component which in the direction of the powder duct points from the material-entry opening toward the material-exit opening. The angle in relation to the plane which is perpendicular to the axis of the powder duct is preferably up to 30°.

According to one further embodiment, the at least one material-entry opening is configured in such a manner that the projection of the entry opening which is perpendicular to the inflow direction of the pulverulent material flowing through the material-entry opening into the powder duct at least corresponds to approximately the width of the powder duct in the region of the material-entry opening. If the dimensions of the material-entry opening and thus of the flow cross section of the inflowing material is adapted in this way to the dimensions of the powder duct in the region of the material-entry opening, the pulverulent material may flow into the powder duct in a uniform and unobstructed manner. If the width of the powder duct at this point were to be less than the flow cross section, for example, this would cause a restriction which would disturb the flow, this being disadvantageous. The projection of the entry opening which is perpendicular to the inflow direction of the pulverulent material may have a diameter of a few millimeters, for example, in particular a diameter in the range of 1 to 3 mm.

One further embodiment of the present invention is distinguished in that the at least one material-entry opening is configured in such a manner that pulverulent material can be introduced into the powder duct having a dynamic component which points in the circumferential direction of the powder duct. According to this embodiment, the pulverulent material is not introduced into the powder duct in a radial manner but in such a manner that it has a dynamic component which points in the circumferential direction of the powder duct. This geometry is particularly advantageous, since the pulverulent material after entering the powder duct does not “impact” the inner wall thereof, but flows thereinto in an unobstructed manner in the circumferential direction. To this end, the supply of pulverulent material into the powder duct may be performed so as to be exactly tangential, or at an angle in relation to the tangents. The angle here may preferably be up to 45°.

In the case of the pulverulent material being supplied having a dynamic component which points in the circumferential direction of the powder duct, helical flow of the pulverulent material is initially established, and the latter may be particularly uniformly distributed across the circumference of the powder duct. The spin of the pulverulent material gradually dissipates in the direction of the material-exit opening, and the uniformly distributed material in that (end) region of the powder duct that faces the material-exit opening still has a dynamic component which only points in the direction of the material-exit opening, on account of which a material focus having good properties, in particular good homogeneity, is obtained. In the case of powder supply having a dynamic component in the circumferential direction of the powder duct it is particularly advantageous for the powder duct to be subdivided into a part-portion having a comparatively pronounced reduction in width and a part-portion having a lesser reduction in width. The pulverulent material is then introduced into the first part-portion and can helically expand therein and dissipate its spin, particularly uniform distribution in the circumferential direction being achieved here. Upon entering the part-portion having lesser width and lesser reduction in width, the material merely has a dynamic component in the direction of the material-exit opening, making for good material-focus properties.

According to one further embodiment of the present invention, a plurality of material-entry openings are provided in the powder duct. On account of powder being supplied at a plurality of points, particularly uniform distribution of the pulverulent material in the circumferential direction of the powder duct is achieved. The material-entry openings in the circumferential direction of the powder duct here are preferably provided so as to be spaced apart in an equidistant manner and/or at the same height.

### BRIEF DESCRIPTION

Some of the embodiments will be described in detail, with reference to the following figures, wherein like designations denote like members, wherein:

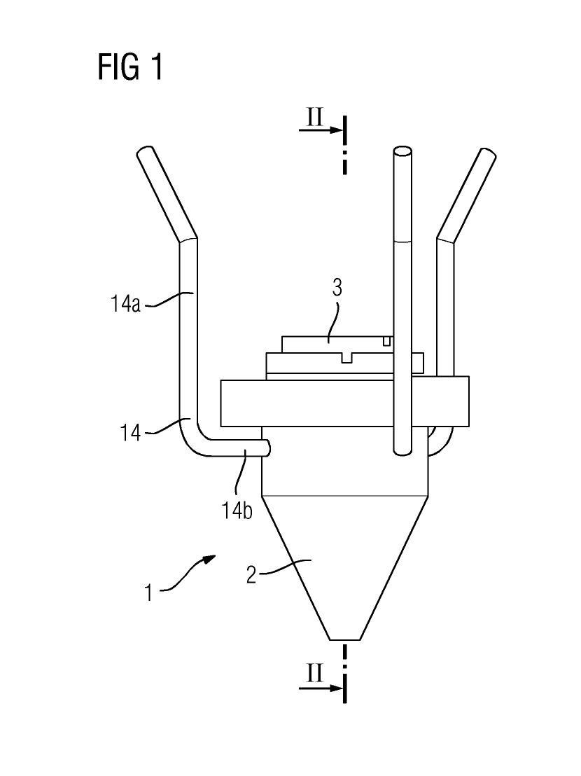

FIG. 1 shows a nozzle for laser powder build-up welding, in an external view;

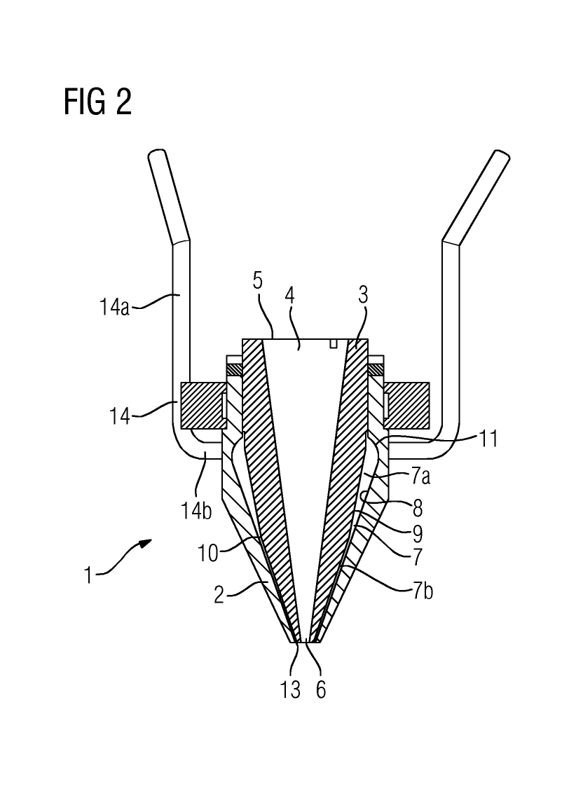

FIG. 2 shows a longitudinal section along the line I-I of the nozzle illustrated in FIG. 1; and

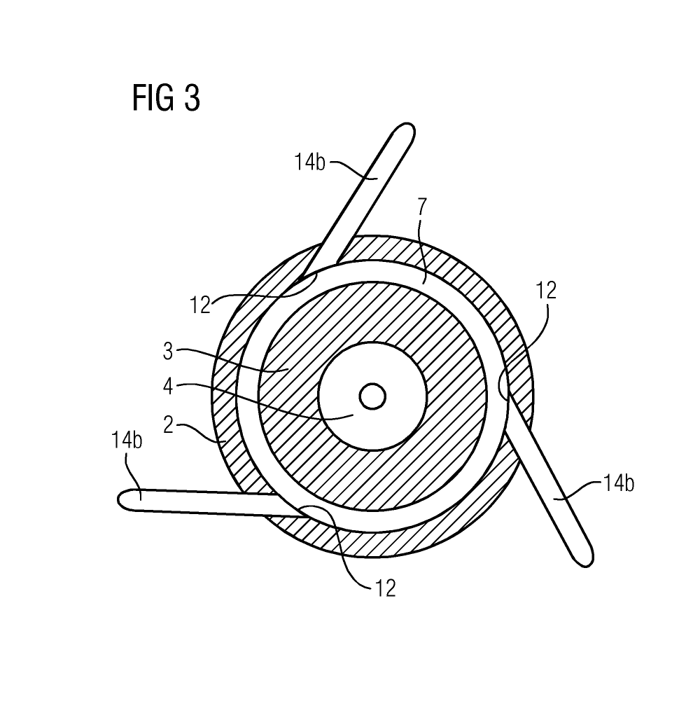

FIG. 3 shows a horizontal section through the nozzle illustrated in FIGS. 1 and 2.

### DETAILED DESCRIPTION

FIG. 1 shows a nozzle according to the embodiments of the invention for laser powder build-up welding, in an external view. As can readily be derived from the sectional illustration in FIG. 2, said nozzle comprises a sleeve-shaped nozzle body 1. The sleeve-shaped nozzle body 1 has a main element 2, which is configured in a sleeve-type manner, and an insert element 3 which is likewise configured in a sleeve-type manner, which is positioned in the main element 2. The insert element 3 here is screwed into the main element 2.

An axial through opening 4 for a processing laser beam (not illustrated in the figure), which tapers toward the front side of the nozzle body 1, which in the figure points downward, is provided in the insert element 3. The through opening 4 on the rear side thereof has a laser-entry opening 5 and at the front side thereof has a laser-exit opening 6. The processing laser beam may be directed through the through opening 4 onto a processing region ahead of the laser-exit opening 6.

An annular powder duct 7, which extends coaxially to the through opening 4, for the supply of a pulverulent material into the processing region is configured between the main element 2 and the insert element 3 of the nozzle body 1. The powder duct 7 surrounds the through opening 4 across approximately ⅔ of the axial length thereof and tapers toward the front side of the nozzle body 1.

The powder duct 7 has a radially outer wall 8 which has the shape of a truncated-cone jacket, that is to say that the radially outer wall 8 is conically tapered toward the front side of the nozzle body 1. The width of the powder duct 7 furthermore decreases toward the laser-exit opening 6, the powder duct 7 being subdivided into a rear part-portion 7a, in which the width decreases in a more pronounced manner, and a front part-portion 7b, in which the width decreases to a lesser extent. In terms of construction, this subdivision of the powder duct 7 is implemented in one part-portion of a more pronounced reduction in width and one part-portion of a less pronounced reduction in width, in that the radially inner wall 9 of the powder duct 7 in the rear part-portion 7a and the front part-portion 7b in each case has the shape of a truncated-cone jacket, thus tapering conically toward the front, the radially inner wall 9 in the rear part-portion 7a having a smaller truncated-cone opening angle than in the front part-portion 7b.

The opening angle of the truncated-cone-jacket-shaped and radially outer wall 8 is 35°. The opening angle of the radially inner wall 9 in the rear part-portion 7a of the powder duct 7 is 24.2°, and in the front part-portion 7b is 33°.

The front part-portion 7b furthermore directly adjoins the rear part-portion 7a. The rear part-portion 7a at a circular edge 10 in the radially inner wall 9 of the powder duct 7 transitions into the front part-portion 7b. The part-portions 7a and 7b in each case extend across approximately half the length of the powder duct 7.

The powder duct 7 at the rear end side 11 thereof is configured in a closed manner. The transition between the rear end wall and the radially outer wall 8 is furthermore configured so as to be rounded. The width of the powder duct 7 in the rear end region thereof is approximately 3 mm.

As can be readily seen in the sectional illustration in FIG. 3, in the closed rear end region of the powder duct 7 a total of three material-entry openings 12 are provided so as to be spaced apart in an equidistant manner in the circumferential direction of the powder duct 7 and at the same height. Pulverulent material may flow through the material-entry openings 12 into the powder duct 7. The pulverulent material, after having passed through the powder duct 7, may exit from the powder duct 7 through the annular material-exit opening 13 which is defined by the front end side of the powder duct 7, which is configured so as to be open. The annular material-exit opening 13 includes the circular laser-exit opening 6 of the through opening 4. The powder duct 7 in the region of the material-exit opening has a width of approximately 250 μm.

The material-entry openings 12 which are provided in the rear end region of the powder duct 7 are configured in such a manner that pulverulent material having a dynamic component in the circumferential direction of the powder duct 7 can be introduced thereinto. Three supply lines 14 which in each case open into the powder duct 7 via the material-entry openings 12 and have a round cross section are provided for the supply of the pulverulent material.

As can be readily seen in FIG. 2, the supply lines 14 comprise in each case one vertical part-portion 14a and one horizontal part-portion 14b, the end region of which opens into the powder duct 7. As can be likewise readily seen in FIG. 3, the horizontal part-portions 14b of the supply lines 14 open into the upper end region of the powder duct 7 in such a manner that at their point of convergence they enclose an angle of approximately 35° with the tangents to the powder duct 7. The inner diameter of the supply lines 14 is approximately 2 mm and thus is just below the width of the powder duct 7 in this region. As a consequence of the non-radial orientation of the supply lines 14 and the round cross section thereof, the material-entry openings 12 have a substantially oval shape.

During operation, nickel-based pulverulent material, which is mixed with a conveying fluid, presently argon, and which has a grain fraction of 25 to 50 micrometers and a dynamic component in the circumferential direction of the powder duct 7, is introduced via the supply lines 14 through the three material-entry openings 12 into the rear end region of the powder duct 7. The volumetric flow of pulverulent material in total, thus for all three part-streams, is approximately 10⁻⁴ m³/s. The kinematic viscosity of argon at room temperature is approximately 1.278*10⁻⁵ m²/s.

Since the powder duct 7, in the rear end region thereof, is configured so as to be rounded, the pulverulent material which is directed via the supply lines 14 into the powder duct 7, may flow into the rear end region of the powder duct 7 in an unobstructed and uniform manner. As a consequence of supplying with a dynamic component in the circumferential direction of the powder duct 7 and of the action of gravitational force, a helical flow geometry is established in the rear part-portion 7a of the powder duct 7, which forms a flow portion.

In practical terms, three intermingling helices of pulverulent material which in each case commence at a material-entry opening are formed. Particularly uniform distribution of the pulverulent material in the circumferential direction of the powder duct 7 may be achieved in this way. The spin of the pulverulent material gradually dissipates via the rear part-portion 7a of the powder duct 7 in the direction of the material-exit opening 13. On account of the decreasing velocity of the powder and the decreasing width of the powder duct 7, the Reynolds number drops along the powder duct 7. The pulverulent material upon entering the front part-portion 7b, which is configured in a gap-type manner, has a velocity component which is only directed in the direction of the material-exit opening 13.

The pulverulent material exits at the front side of the nozzle body 1, via the annular material-exit opening 13, from the powder duct 7 and as a consequence of the shape of the powder duct 7, which tapers conically toward the front, is concentrated on a point ahead of the material-exit opening 13, the so-called material focus. As a consequence of the particularly uniform distribution of the pulverulent material across the circumference of the powder duct 7 in the rear part-portion 7a and the subsequent movement of material in the front part-portion 7b, which is entirely directed in the direction of the material-exit opening 13, the material focus is distinguished by particularly good homogeneity.

By way of the processing laser beam which simultaneously spreads by way of the through opening 4 through the nozzle body 1, the pulverulent material is welded onto the surface of a workpiece (not illustrated in the figure) which is located ahead of the laser-exit opening 6 and of the material-exit opening 13.

As a consequence of the design embodiment of the powder duct 7 according to the invention, blocking of the nozzle during operation is prevented. There are in particular no deposits of pulverulent material in the powder duct 7. The nozzle according to the embodiments of the invention here may be operated in a perpendicular manner as well as at a small or large attitude, without the functional capability of said nozzle being compromised thereby. As a result, 3-D structures may also be readily produced using the nozzle according to the invention.

While the invention has been illustrated and described in detail by way of the preferred exemplary embodiment, the invention is not limited to the disclosed examples, and other variations may be derived therefrom by a person skilled in the art without departing from the scope of protection of the invention.

1. A nozzle for laser powder build-up welding, comprising a sleeve-shaped nozzle body in which an axial through opening for a processing laser beam, having a laser-entry opening at the rear side thereof and a laser-exit opening at the front side thereof, is configured, wherein the through opening is tapered toward the laser-exit opening and, for the supply of pulverulent material into an operating region ahead of the laser-exit opening, has an annular powder duct which surrounds the through opening across at least part of the axial length thereof and extends coaxially thereto, said operating region having at least one material-entry opening in the radially outer wall thereof and a material-exit opening which is defined by the open front end-side of the powder duct, and tapering toward the front, wherein the powder duct is configured in such a manner that the angle enclosed between the radially outer wall of the powder duct and the axis of the powder duct is constant at least in the region which extends from the at least one material-entry opening up to the material-exit opening, or decreases in the direction of the material-exit opening.

2. The nozzle as claimed in claim 1, wherein the width of the powder duct at least in the region which extends from the at least one material-entry opening up to the material-exit opening decreases in the direction of the material-exit opening.

3. The nozzle for laser powder build-up welding, as claimed in claim 2, comprising a sleeve-shaped nozzle body in which an axial through opening for a processing laser beam, having a laser-entry opening at the rear side thereof and a laser-exit opening at the front side thereof, is configured, wherein the through opening is tapered toward the laser-exit opening and, for the supply of pulverulent material into an operating region ahead of the laser-exit opening, has an annular powder duct which surrounds the through opening across at least part of the axial length thereof and extends coaxially thereto, said operating region having at least one material-entry opening in the radially outer wall thereof and a material-exit opening which is defined by the open front end-side of the powder duct, and tapering toward the front, wherein the width of the powder duct in the region which extends from the at least one material-entry opening up to the material-exit opening continuously decreases in the direction of the material-exit opening.

4. The nozzle as claim in claim 2, wherein the powder duct in the region which extends from the at least one material-entry opening up to the material-exit opening comprises a rear part-portion, in which the width of said powder duct decreases in a more pronounced manner, and a front part-portion, in which the width of said powder duct decreases to a lesser extent.

5. The nozzle as claimed in claim 4, wherein the radially inner wall of the powder duct in the rear and the front part-portions in each case has the shape of a truncated-cone jacket, and that in particular the rear part-portion has a smaller truncated-cone opening angle than the front part-portion.

6. The nozzle as claimed in claim 5, wherein the front part-portion directly adjoins the rear part-portion, and the front and the rear part-portions in each case extend across approximately half of the region of the powder duct which extends from the at least one material-entry opening up to the material-exit opening.

7. The nozzle as claimed in claim 1, wherein the sleeve-shaped nozzle body has a sleeve-type main element and a sleeve-type insert element which is positioned in the main element, and that the through opening for the processing laser beam is configured in the insert element.

8. The nozzle as claimed in claim 7, wherein the powder duct is configured between the main element and the insert element.

9. The nozzle as claimed in claim 1, wherein in the powder duct the transition between the rear end wall and the radially outer wall is configured so as to be rounded.

10. The nozzle as claimed in claim 1, wherein the at least one material-entry opening is configured in such a manner that pulverulent material can be introduced into the powder duct in the direction of the material-exit opening at an angle in relation to a plane which is perpendicular to the axis of the powder duct.

11. The nozzle as claimed in claim 1, wherein the at least one material-entry opening is configured in such a manner that the projection of the material-entry opening which is perpendicular to the inflow direction of the pulverulent material flowing through the material-entry opening into the powder duct at least corresponds to approximately the width of the powder duct in the region of the material-entry opening.

12. The nozzle as claimed in claim 1, wherein the at least one material-entry opening is configured in such a manner that pulverulent material can be introduced into the powder duct having a dynamic component which points in the circumferential direction of the powder duct.

13. The nozzle as claimed in claim 1, wherein a plurality of material-entry openings are provided in the powder duct.

14. The nozzle as claimed in claim 13, wherein the material-entry openings in the circumferential direction of the powder duct are provided so as to be spaced apart in an equidistant manner and/or at the same height.
